(19) United States
(12) Patent Application Publication
(10) Pub. No.: US 2022/0292591 A1
(43) Pub. Date: Sep. 15, 2022

(54) EZ-Rider Vehicle Demonstration Reservation System

(71) Applicant: Vince Denais, Oxnard, CA (US)

(72) Inventor: Vince Denais, Oxnard, CA (US)

(21) Appl. No.: 17/196,552

(22) Filed: Mar. 9, 2021

(51) Int. Cl. G06Q 30/06; G06Q 10/02; G06Q 40/08; G06Q 50/30

(52) U.S. Cl. CPC G06Q 30/0645; G06Q 10/02; G06Q 40/08; G06Q 50/30

(57) ABSTRACT

A method of associating an operator with a vehicle and insurance coverage for demonstration purposes at a retail establishment is disclosed. More specifically, the method associates an operator with an automobile, a motorcycle, a boat, or an airplane for purposes of demonstrating the vehicle to the operator for sales and/or rental purposes. Also, the method may simultaneously provide insurance to the operator for the term of the demonstration.

### CROSS-REFERENCE TO RELATED APPLICATIONS

Not applicable.

### FIELD OF THE INVENTION

The invention relates to a method of associating an operator with a vehicle and insurance coverage for demonstration purposes at a retail establishment. More specifically, the invention relates to a method of associating an operator with an automobile, a motorcycle, a boat, or an airplane for purposes of demonstrating the vehicle to the operator for sales and/or rental purposes. Also, the invention simultaneously provides insurance to the operator for the term of the demonstration.

### BACKGROUND OF THE INVENTION

The invention relates to a method of associating a prospective operator with an automobile, a motorcycle, a boat, or an airplane for purposes of demonstrating the vehicle to the operator for sales and/or rental purposes. Since insurance coverage is an important part of such transactions, an appropriate spot insurance policy may be associated with the operator and the vehicle for the time period of the demonstration.

Accordingly, a first embodiment of the present invention is directed towards a method of associating a prospective operator with an automobile, a motorcycle, a boat, or an airplane for purposes of demonstrating the vehicle to the operator for sales and/or rental purposes.

A second embodiment of the present invention is directed towards a method of associating a prospective operator with an automobile, a motorcycle, a boat, or an airplane for purposes of demonstrating the vehicle to the operator for sales and/or rental purposes and issuing an appropriate spot insurance policy covering the operator, the vehicle, and the time period of the demonstration.

These and all related variants of the same invention are hereby implicitly disclosed by this specification.

### SUMMARY OF THE INVENTION

In a first embodiment of the present invention, a method of associating a prospective operator with an automobile, a motorcycle, a boat, or an airplane for purposes of demonstrating the vehicle to the operator for sales and/or rental purposes is disclosed.

The prospective operator uses a smart phone, a tablet computer, or a personal computer to inspect the reservation website or other web-presence of a vehicle dealer or rental facility. As a first step, the prospective operator chooses a date, a time, and a location (if multiple locations are available) that he or she wishes to reserve a vehicle for a demonstration ride. As a second step, the prospective operator next inspects a list of vehicles being offered for demonstration by the vehicle dealer or rental facility at the time selected. The prospective operator chooses one of the vehicles for the demonstration ride at the time chosen supra. As a third step, the prospective operator then provides basic financial information, including identification and licensure data. Such identifications and licensure data ordinarily is provided by means of a driver's license or other identity card. After the system queries one or more databases to verify the provided identification and licensure data, the system reserves the requested vehicle for the requested period of time. Those having skill in the art will recognize that these three steps may be interchanged in order or occur at the same time. When the prospective operator arrives at the dealership, the prospective operator retrieves the key or other vehicle access token and operates the vehicle for the planned period of time. The key or other vehicle access token may be retrieved by scanning a QR code or some other type of visual cue, such as a photograph of a trademark or a photograph of a building (thus identifying the dealership) using the prospective operator's smart phone or tablet computer. This indicates that the prospective operator is at the dealership and is ready to test drive the vehicle.

In a second embodiment of the present invention, a method of associating a prospective operator with an automobile, a motorcycle, a boat, or an airplane for purposes of demonstrating the vehicle to the operator for sales and/or rental purposes is disclosed. Simultaneously, a spot insurance policy covering the prospective operator for the selected vehicle for the time selected by the user is disclosed.

The prospective operator uses a smart phone, a tablet computer, or a personal computer to inspect the reservation website or other web-presence of a vehicle dealer or rental facility. As a first step, the prospective operator chooses a date, a time, and a location (if multiple locations are available) that he or she wishes to reserve a vehicle for a demonstration ride. As a second step, the prospective operator next inspects a list of vehicles being offered for demonstration by the vehicle dealer or rental facility at the time selected. The prospective operator chooses one of the vehicles for the demonstration ride at the time chosen supra. As a third step, the prospective operator then provides basic financial information, including identification and licensure data. Such identifications and licensure data ordinarily is provided by means of a driver's license or other identity card. After the system queries one or more databases to verify the provided identification and licensure data, the system reserves the requested vehicle for the requested period of time and issues a spot insurance policy covering the prospective operator for the selected period of time. Those having skill in the art will recognize that these three steps may be interchanged in order or occur at the same time. When the prospective operator arrives at the dealership, the prospective operator retrieves the key or other vehicle access token and operates the vehicle for the planned period of time. The key or other vehicle access token may be retrieved by scanning a QR code or some other type of visual cue, such as a photograph of a trademark or a photograph of a building (thus identifying the dealership) using the prospective operator's smart phone or tablet computer. This indicates that the prospective operator is at the dealership and is ready to test drive the vehicle.

### BRIEF DESCRIPTION OF THE DRAWINGS

FIG. 1 is a schematic showing the flow of operations in a first embodiment of the invention. In this embodiment insurance is not provided to the operator for the term of the demonstration.

FIG. 2 is a schematic showing the flow of operations in a second embodiment of the invention. In this embodiment insurance is provided to the operator for the term of the demonstration.

### DETAILED DESCRIPTION OF THE INVENTION

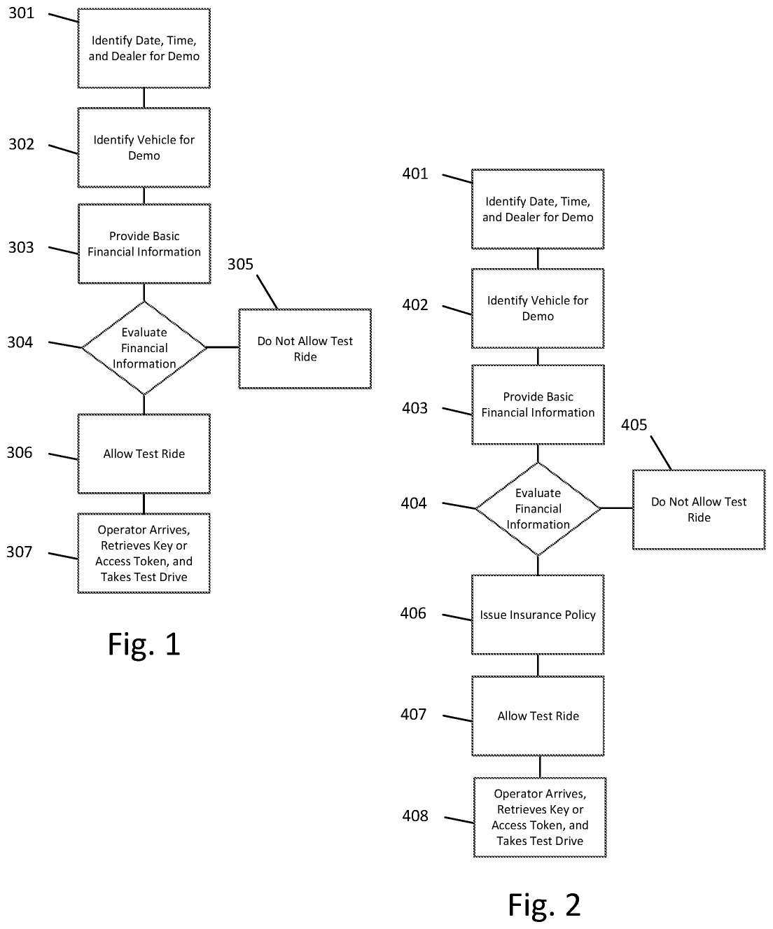

Turning now to FIG. 1, in a first embodiment of the present invention, a method of associating a prospective operator with an automobile, a motorcycle, a boat, or an airplane for purposes of demonstrating the vehicle to the operator for sales and/or rental purposes is disclosed.

The prospective operator uses a smart phone, a tablet computer, or a personal computer to interact with the reservation website or other web-presence of a vehicle dealer or rental facility. As a first step, the prospective operator chooses a date, a time, and a location (if multiple locations are available) that he or she wishes to reserve a vehicle for a demonstration ride 301. As a second step, the prospective operator next inspects a list of vehicles being offered for demonstration by the vehicle dealer or rental facility at the time selected. The prospective operator chooses one of the vehicles for the demonstration ride at the time chosen supra 302. As a third step, the prospective operator then provides basic financial information, including identification and licensure data 303. If the system queries one or more databases to verify the provided identification and licensure data and evaluates the financial information 304 indicating that the prospective operator is not qualified to reserve a test ride through the system, the system denies the reservation for the requested vehicle for the requested period of time 305. If the system queries one or more databases to verify the provided identification and licensure data and evaluates the financial information 304 indicating that the prospective operator is qualified to reserve a test ride through the system, the system allows the reservation for the requested vehicle for the requested period of time 306. Next, the prospective operator arrives at the dealership and retrieves the key or access token 307. This may be done by scanning a QR code or some other type of visual cue, such as a photograph of a trademark or a photograph of a building (thus identifying the dealership) using the prospective operator's smart phone or tablet computer. Finally, the prospective operator takes the vehicle for a test ride. After the demonstration ride, the operator returns the vehicle to the dealership and returns the key or other vehicle access token to the dealer.

Those having skill in the art will recognize that these three steps may be interchanged in any order or occur at the same time. The combination of all three steps may occur together in one geographic place or disjointedly. For example, all of the three steps may take place at the dealership on, or near, the sales floor and the vehicles that one may select for a test drive. In an alternative embodiment of the present invention, the first of the three steps occurs away from the dealership by means of the user's smart phone, tablet computer, or personal computer whilst the two final steps occur at or near the dealership on a tablet computer or personal computer owned by the dealer. In another embodiment of the invention, the first two steps occurs away from the dealership by means of the user's smart phone, tablet computer, or personal computer whilst the final step occurs at or near the dealership on a tablet computer or personal computer owned by the dealer. When the prospective operator arrives at the dealership, the prospective operator retrieves the key or other vehicle access token and operates the vehicle for the planned period of time.

Turning now to FIG. 2, in a second embodiment of the present invention, a method of associating a prospective operator with an automobile, a motorcycle, a boat, or an airplane for purposes of demonstrating the vehicle to the operator for sales and/or rental purposes is disclosed. Simultaneously, a spot insurance policy is issued to the prospective operator.

The prospective operator uses a smart phone, a tablet computer, or a personal computer to interact with the reservation website or other web-presence of a vehicle dealer or rental facility. As a first step, the prospective operator chooses a date, a time, and a location (if multiple locations are available) that he or she wishes to reserve a vehicle for a demonstration ride 401. As a second step, the prospective operator next inspects a list of vehicles being offered for demonstration by the vehicle dealer or rental facility at the time selected. The prospective operator chooses one of the vehicles for the demonstration ride at the time chosen supra 402. As a third step, the prospective operator then provides basic financial information, including identification and licensure data 403. If the system queries one or more databases to verify the provided identification and licensure data and evaluates the financial information 404 indicating that the prospective operator is not qualified to reserve a test ride through the system, the system denies the reservation for the requested vehicle for the requested period of time 405. If the system queries one or more databases to verify the provided identification and licensure data and evaluates the financial information 404 indicating that the prospective operator is qualified to reserve a test ride through the system, the system issues a spot insurance policy 406 and reserves the requested vehicle for the requested period of time and allows the test ride to occur 407. Next, the prospective operator arrives at the dealership and retrieves the key or access token 408. This may be done by scanning a QR code or some other type of visual cue, such as a photograph of a trademark or a photograph of a building (thus identifying the dealership) using the prospective operator's smart phone or tablet computer. Finally, the prospective operator takes the vehicle for a test ride. After the demonstration ride, the operator returns the vehicle to the dealership and returns the key or other vehicle access token to the dealer.

Those having skill in the art will recognize that these three steps may be interchanged in order or occur at the same time. The combination of all three steps may occur together in one geographic place or disjointedly. For example, all of the three steps may take place at the dealership on, or near, the sales floor and the vehicles that one may select for a test drive. In an alternative embodiment of the present invention, the first of the three steps occurs away from the dealership by means of the user's smart phone, tablet computer, or personal computer whilst the two final steps occur at or near the dealership on a tablet computer or personal computer owned by the dealer. In another embodiment of the invention, the first two steps occurs away from the dealership by means of the user's smart phone, tablet computer, or personal computer whilst the final step occurs at or near the dealership on a tablet computer or personal computer owned by the dealer. When the prospective operator arrives at the dealership, the prospective operator retrieves the key or other vehicle access token and operates the vehicle for the planned period of time.

What is claimed is:

1. A method of electronically reserving a demonstration vehicle at a sales, leasing, or rental establishment comprising the following steps:
a) a prospective operator selects a sales, leasing, or rental establishment from a group of sales, leasing, or rental establishments;
b) the prospective operator selects a vehicle to reserve for a demonstration at the selected sales, leasing, or rental establishment from a group of vehicles;
c) the prospective operator selects the date, time, and the length of time for the demonstration;
d) the prospective operator supplies basic financial information including identification and licensure data;
e) the prospective operator receives approval of the demonstration, or, alternately receives a denial based on the evaluation of the financial information;
f) if an approval was received, the prospective operator travels to the sales, leasing, or rental establishment, scans a QR code identifying the sales, leasing, or rental establishment, retrieves the key or access token, and takes the selected vehicle for a demonstration.

2. A method of electronically reserving a demonstration vehicle at a sales, leasing, or rental establishment comprising the following steps with spot insurance coverage:
a) a prospective operator selects a sales, leasing, or rental establishment from a group of sales, leasing, or rental establishments;
b) a prospective operator selects a vehicle to reserve for a demonstration at the selected sales, leasing, or rental establishment from a group of vehicles;
c) a prospective operator selects the date, time, and the length of time for the demonstration;
d) a prospective operator supplies basic financial information including identification and licensure data;
e) a prospective operator receives approval of the demonstration, or, alternately receives a denial based on the evaluation of the financial information;
g) if an approval was received, a spot insurance policy is issued to the prospective operator and the prospective operator travels to the sales, leasing, or rental establishment, scans a QR code identifying the sales, leasing, or rental establishment, retrieves the key or access token, and takes the selected vehicle for a demonstration.
